(19) United States
(12) Patent Application Publication
(10) Pub. No.: US 2009/0103458 A1
(43) Pub. Date: Apr. 23, 2009

(54) AVOIDANCE OF INCORRECT CLASSIFICATION OF DESIRED MESSAGES AS SPAM-OVER-INTERNET-TELEPHONY MESSAGES

(75) Inventors: Joachim Charzinski, Munchen (DE); Walter Klausberger, Wolfpassing (AT)

Correspondence Address: BELL, BOYD & LLOYD, LLP, P.O. BOX 1135, CHICAGO, IL, 60690, US

(73) Assignee: Nokia Siemens Networks GmbH & Co., KG, Muchen (DE)

(21) Appl. No.: 12/293,366

(22) PCT Filed: Mar. 2, 2007
(86) PCT No.: PCT/EP2007/052004

§ 371 Date: Oct. 29, 2008

(30) Foreign Application Priority Data
Mar. 17, 2006 (DE) 10 2006 012 439.1

(51) Int. Cl. H04L 12/16

(52) U.S. Cl. 370/259

(57) ABSTRACT

The subject matter of the invention is a method and an apparatus for avoiding incorrect classification of desired messages as spam-over-Internet-telephony messages, SPIT messages for short, and accordingly a connection request is forwarded within communication networks from a terminal belonging to a first subscriber to a terminal belonging to a second subscriber, a first communication network being a home communication network for the first subscriber, and the first subscriber's terminal being in a registration state which characterizes that communication network in which the first subscriber's terminal is registered at the time of the connection request, where subscriber-related information, falsifying the identity of the first subscriber, which the connection request holds regarding the registration state of the first subscriber's terminal gives rise to the possibility of incorrect classification of the connection request by the second subscriber. A server system routes the connection request via a communication apparatus located in the home communication network to the second subscriber's terminal, the communication apparatus avoiding incorrect classification of the connection request by the second subscriber before the connection request is forwarded by removing the subscriber-related information falsifying the identity of the first subscriber which the connection request holds regarding the registration state of the first subscriber's terminal.

### CLAIM FOR PRIORITY

This application is a national stage application of PCT/EP2007/052004, filed Mar. 2, 2007, which claims the benefit of priority to German Application No. 10 2006 012 439.1, filed Mar. 17, 2006, the contents of which hereby incorporated by reference.

### TECHNICAL FIELD OF THE INVENTION

The invention relates to a method and an apparatus for avoiding incorrect classification of desired messages as spam-over-Internet-telephony messages (SPIT messages for short) in a communication network.

### BACKGROUND OF THE INVENTION

The term “spamming” denotes the bulk dispatch of undesired messages (“spam”). “Spamming” is facilitated by the simple and convenient access to electronic media which generally allow messages to be dispatched to a large number of recipients in a short space of time and at little cost. The contents of such “spam” messages are often of a commercial nature but “spam” with dubious contents predominates, in particular. One very well known form of “spam” is the bulk dispatch of emails for advertising purposes. In addition to email “spam”, there are other forms, for example “spam” relating to instant messaging, Usenet newsgroups, Internet search engines, weblogs or mobile radio.

As already mentioned, “spam” is facilitated by the fact that the perpetrators, for example advertisers, incur virtually no effective costs, apart from the management of appropriate email address lists, as a result of “spamming”. In addition to the obvious disadvantages to the respective recipients caused by the dispatch of undesired messages, “spamming” has in the meantime given rise to high costs which must be borne by everybody. These are, on the one hand, indirect costs which arise, for example, as a result of a loss of productivity or overfilled electronic mailboxes. More serious are the costs incurred by the respectively affected infrastructure providers, for example Internet service providers (ISP): it is often necessary to increase the bandwidth capacities since the existing bandwidths are no longer sufficient to cope with the flood of “spam”.

Although “spamming” is outlawed by everybody and the legal position in Germany and other countries is currently being adapted, “spamming” is likely to increase further since the obstacles to this type of message dispatch are very small.

With the increasing spread of Internet telephony (Voice over IP, VoIP for short), it is expected that VoIP subscribers will be increasingly exposed to so-called SPIT (Spam-over-Internet Telephony). At present, advertising calls to conventional PSTN subscribers (PSTN: Public Switched Telephone Network) are normally always charged to the caller. In contrast, calls to VoIP subscribers can be made almost at no cost to the caller on account of the different charging model, which means that a massive volume of SPIT can be expected for the future. In particular, the possibility of dispatching recorded voice files in bulk ought to be of interest to advertisers. It can be assumed that the affected VoIP subscribers will demand that their respective VoIP provider take suitable measures in order to be protected from unwanted calls.

Whereas connections in the PSTN are circuit-switched or, in mobile radio, an identification can be made using the SIM card of the caller, identification of a caller in IP telephony is problematic: communication between two subscribers takes place here only virtually from end point to end point since they are packet-switched connections.

As a measure to counteract SPIT, so-called white lists and black lists are being used, inter alia. A white list contains subscriber-specific information for a subscriber X relating to those other subscribers Y in the communication network which have been classified as trustworthy and are therefore authorized to call subscriber X. In contrast, a black list contains subscriber-specific information relating to those other subscribers Y which have not been classified as trustworthy and are therefore not authorized to call subscriber X.

However, SPIT protection with the aid of white and black lists may be ineffective, for example in the case of so-called “roaming” of a subscriber, that is to say the use of a communication terminal associated with a subscriber in a communication network other than the home network of the subscriber, since it is not possible to guarantee that every network operator will always forward the actual call number for a “roaming” subscriber to a different communication network.

In addition, so-called SPIT filters are known, which, in addition to the sender address of a calling subscriber, additionally evaluate one or more entries in the header of an SIP invite message in order to assess the likelihood of SPIT in the message in question. This makes it possible to increase the reliability of SPIT filters since it is thus possible to recognize sender addresses which have been falsified. However, the disadvantage of this method is that a call from a “roaming” subscriber from a different communication network would be incorrectly classified as SPIT on account of the header entries in the SIP invite message in question differing greatly from header entries which are known for this subscriber.

One simple solution to the problem would be to ensure that the call number for a caller is forwarded from all communication networks. However, a reliable solution on this basis would require the cooperation of all network operators, with the result that evasion solutions are additionally required for the situation in which a network operator does not forward the actual call number for its “roaming” subscribers. CTI solutions (CTI: Computer Telephony Integration) with a corresponding functionality exist for enterprise communication networks based on TDM telephony. However, these solutions cannot be used in a public IP communication network.

### SUMMARY OF THE INVENTION

The invention relates to a method and an apparatus such that incorrect classification of desired messages as spam-over-Internet-telephony messages (SPIT messages for short) can be avoided.

In one embodiment of the invention, there is a method for avoiding incorrect classification of desired messages as spam-over-Internet-telephony messages (SPIT messages for short), according to which a connection request is forwarded within communication networks from a terminal associated with a first subscriber to a terminal associated with a second subscriber, a first communication network being a home communication network of the first subscriber, and the terminal associated with the first subscriber being in a registration state which characterizes that communication network in which the terminal associated with the first subscriber is registered at the time of the connection request, subscriber-related information, which is contained in the connection request, falsifies the identity of the first subscriber and relates to the registration state of the terminal associated with the first subscriber, giving rise to the possibility of incorrect classification of the connection request by the second subscriber. A server system passes the connection request to the terminal associated with the second subscriber via a communication apparatus located in the home communication network, the communication apparatus avoiding incorrect classification of the connection request by the second subscriber by removing the subscriber-related information, which is contained in the connection request, falsifies the identity of the first subscriber and relates to the registration state of the terminal associated with the first subscriber, before forwarding the connection request.

Another embodiment of the invention relates to an apparatus for carrying out the method described.

The invention entails the advantage that incorrect classification of desired messages as spam-over-Internet-telephony messages (SPIT messages for short) can be avoided.

### BRIEF DESCRIPTION OF THE INVENTION

One exemplary embodiment of the invention is illustrated in the drawings and is described in more detail below.

In the drawings:

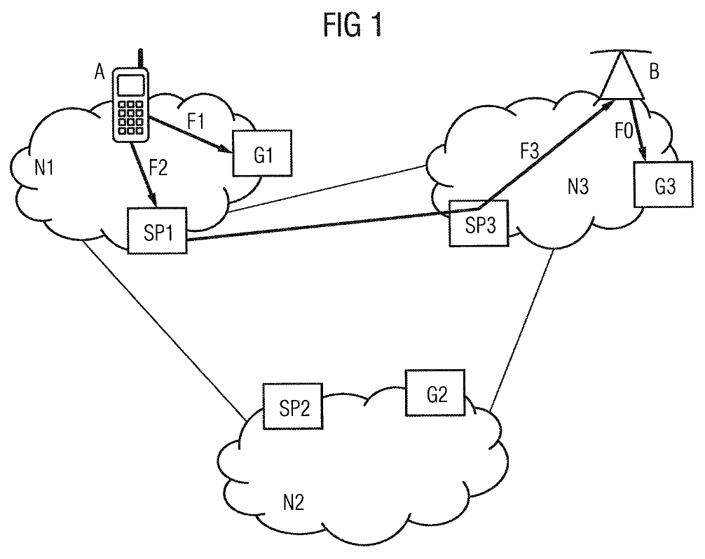

FIG. 1: shows communication networks with SIP servers as well as registrars and subscribers, with subscribers in respective home communication networks.

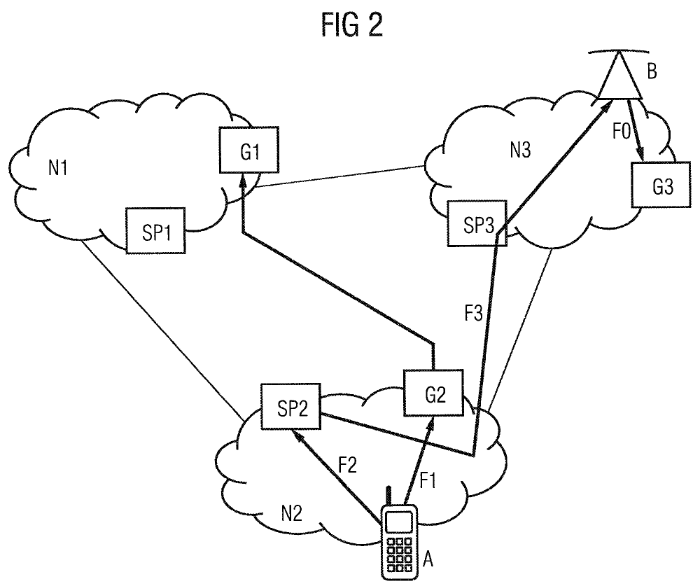

FIG. 2: shows communication networks with SIP servers as well as registrars and subscribers, where a first subscriber is in the “roaming” state and a second subscriber is in the home communication network.

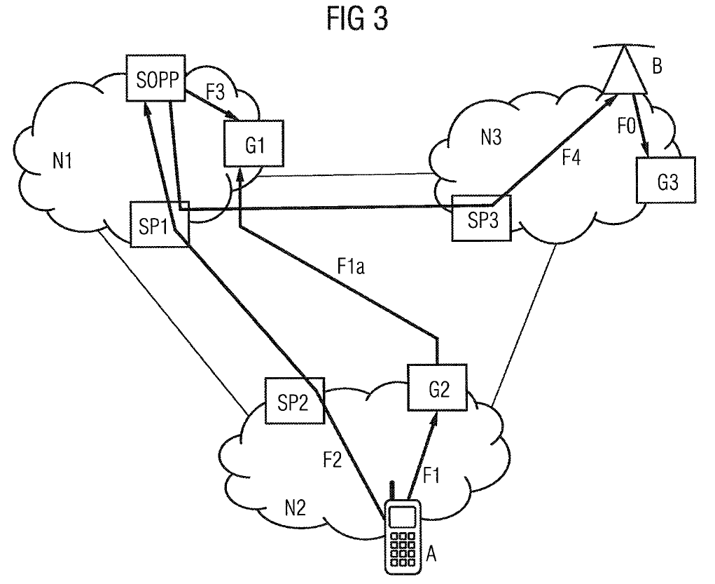

FIG. 3: shows communication networks with SIP servers as well as registrars and subscribers, where a first subscriber is in the “roaming” state after registering using an SIP Originator Preserving Proxy SOPP and a second subscriber is in the home communication network N3.

### DETAILED DESCRIPTION OF THE INVENTION

The invention proposes passing a call from a first subscriber A via a proxy system (SIP Originator Preserving Proxy, SOPP). In this case, the SOPP ensures, according to the invention, that correct subscriber-related information relating to the first subscriber A, in particular the call number for the first subscriber A, is signaled.

Authorization certificates for the first subscriber A can be optionally checked by the proxy system SOPP, for example by incorporating a first registrar G1. A registrar G1, G2, G3 is an apparatus in a communication network N1, N2, N3 for registering subscribers and optionally for checking subscriber-related authorization certificates. In mobile radio communication networks, a registrar corresponds functionally, for example, to the unit comprising the Home Location Register and the Visitor Location Register.

FIG. 1 shows three communication networks N1, N2, N3 with three SIP servers SP1, SP2, SP3 as well as three registrars G1, G2, G3, a first subscriber A and a second subscriber B. Both subscribers A, B are registered in their respective home communication network N1, N3. The SIP servers SP1, SP2, SP3 are preferably represented by soft switches or SIP proxies. Message flows F0, F1, F2, F3 are also illustrated in FIG. 1. The second subscriber B uses a first message flow F0 to register with a third registrar G3, the third registrar G3 being situated in the home communication network N3 of the second subscriber B. The first subscriber A uses a second message flow F1 to register with a first registrar G1, the first registrar G1 being situated in the home communication network N1 of the first subscriber A.

The first subscriber A then uses a third message flow F2 to signal the desire to set up a call to the second subscriber B. This third message flow F2 is forwarded, using a fourth message flow F3, from a first SIP proxy SP1 to the second subscriber B via a third SIP proxy. In the event of the second subscriber B using a white list in order to protect itself against unwanted calls, the information transmitted using the fourth message flow F3 may be optionally evaluated with regard to possible SPIT before the terminal associated with the second subscriber B signals the incoming call, for example using a bell signal, in the case of a call which is not SPIT.

FIG. 2 shows the three communication networks N1, N2, N3 with the three SIP servers SP1, SP2, SP3 as well as the three registrars G1, G2, G3 and the two subscribers A, B. In contrast to the scenario illustrated in FIG. 1, the first subscriber A is in the “roaming” state in this case: the first subscriber A, with its terminal, stays in the second communication network N2. A “roaming” agreement, for example, exists between the network operators of the first communication network N1 and the second communication network N2, with the result that subscribers belonging to the first communication network N1 can also register in the second communication network N2 and vice versa. At the time illustrated, the second subscriber B is registered in its home communication network N3. In the case of a desired communication link between the first subscriber A and the second subscriber B, the first subscriber A transmits a registration message in the form of a first message flow F1 to a second registrar G2, the second registrar G2 being situated in the second communication network N2. The second registrar G2 then transmits a confirmation request F1a to the first registrar G1, the first registrar G1 being situated in the home communication network N1 of the first subscriber A. In the event of the first registrar G1 transmitting a positive confirmation to the second register G2, the first subscriber A is registered in the second communication network N2. The first subscriber A then uses a second message flow F2 and a third message flow F3, for example, to set up a communication link to the second subscriber B via a second SIP proxy SP2 and a third SIP proxy SP3. The abovementioned problem of the third message flow F3 not containing the correct and actual sender address for the first subscriber A may arise in this case.

FIG. 3 shows the three communication networks N1, N2, N3 with the three SIP servers SP1, SP2, SP2 as well as the three registrars G1, G2, G3 and the two subscribers A, B. Like in the scenario illustrated in FIG. 2, the first subscriber A is in the “roaming” state as a result of registration in the second communication network N2 using the proxy system SOPP. At the time illustrated, the second subscriber B is registered in its home communication network N3. In the case of a desired communication link between the first subscriber A and the second subscriber B, the first subscriber A transmits a registration message in the form of a first message flow F1 to a second registrar G2, the second registrar G2 being situated in the second communication network N2. The second registrar G2 then transmits a confirmation request F1a to the first registrar G1, the first registrar G1 being situated in the home communication network N1 of the first subscriber A. In the event of the first registrar G1 transmitting a positive confirmation to the second registrar G2, the first subscriber A is registered in the second communication network N2.

However, in contrast to the scenario illustrated in FIG. 2, the first subscriber A does not set up a direct communication link to the terminal associated with the second subscriber B in the situation illustrated in FIG. 3. Instead, the communication link is routed to the terminal associated with the second subscriber B via the proxy system SOPP.

In order to set up a call via the proxy system SOPP, the first subscriber A must first of all be authenticated in the proxy system SOPP. For this purpose, the first subscriber A transmits a registration message F2 from its terminal to the proxy system SOPP via a second SIP proxy SP2 and the first SIP proxy SP1, the second SIP proxy SP2 being situated in the second communication network N2 and the first SIP proxy SP1 and the proxy system SOPP being situated, for example, in the first communication network N1 and thus in the home communication network N1 of the first subscriber A. Over the course of this registration operation, the first subscriber A transmits, for example, its call number and a PIN code or alternatively a password to the proxy system SOPP. The proxy system SOPP then optionally authenticates the first subscriber A by sending a confirmation request F3 to the first registrar G1, whereupon the first registrar G1 checks the subscriber-related information relating to the first subscriber A, for example, and returns a positive confirmation to the proxy system SOPP, if appropriate.

According to the invention, the proxy system SOPP then passes an SIP invite message, which is transmitted from the terminal associated with the first subscriber A in the course of setting up the communication link, via an SIP server in the home communication network of the first subscriber A, for example via the first SIP proxy SP1. In the course of forwarding the communication link to the terminal associated with the second subscriber B, the first SIP proxy SP1 removes the information relating to the “roaming” state of the first subscriber A from the SIP header of the SIP invite message transmitted from the terminal associated with the first subscriber A. Removing the information relating to the “roaming” state of the first subscriber A from the SIP header of the SIP invite message means that it is no longer clear in the further course of the communication link that the call in question is a call from a “roaming” subscriber A. The call in question is then perceived by the called second subscriber B as a call from the home communication network of the first subscriber A. This reduces the risk of a call being incorrectly classified as SPIT on account of the header entries in the SIP invite message in question differing greatly from header entries known for the first subscriber A. In the situation illustrated in FIG. 3, the communication link is set up, starting with the proxy system SOPP, using a fourth message flow F4 from the proxy system SOPP to the terminal associated with the second subscriber B via the first SIP proxy SP1 and the third SIP proxy SP3, for example.

The scenario illustrated in FIG. 3 represents one possible exemplary architecture. Other network architectures are conceivable.

In order to protect the optional authentication operation from replay attacks, for example, the PIN code and/or the password can be transmitted, for example, using a challenge response method.

In another form of the invention, the registration state characterizes a communication network N2, N3 which is different from the home communication network N1 and in which the terminal associated with the first subscriber A is registered at the time of the connection request F2, F4. This affords the advantage that the terminal associated with the first subscriber A can also be used in a communication network N2, N3 other than the home communication network, the method according to the invention nevertheless ensuring that incorrect classification of the connection request F2, F4 by the second subscriber B is avoided.

In another form of the invention, removing the subscriber-related information, which is contained in the connection request F2, F4, falsifies the identity of the first subscriber A and relates to the registration state of the terminal associated with the first subscriber A, involves forwarding a correct call number for the first subscriber A to the terminal associated with the second subscriber B. This has the advantage that incorrect classification of the connection request F2, F4 by the second subscriber B is avoided even when a simple black or white list is used by the second subscriber B, with only call numbers being stored in the black or white list, for example.

In another form of the invention, the terminal associated with the first subscriber A is permanently assigned to the first subscriber A.

In another form of the invention, the terminal associated with the first subscriber A can be temporarily assigned to the first subscriber A. This has the advantage, for example, that the first subscriber A can use any desired terminal inside a communication network N1, N2, N3 by logging onto any desired terminal using a personal PIN code, for example. If, when transmitting subscriber-related information which is contained in a connection request F2, F4 initiated by the first subscriber A and relates to the registration state of the terminal associated with the first subscriber A, a terminal address which uniquely identifies the terminal associated with the first subscriber A, for example a MAC address, is transmitted, for example, there is also the possibility of incorrect classification of the connection request F2, F4 by the called second subscriber B in the case of a connection request inside a communication network, for example the home communication network N1, if, for example, the relevant MAC address of the terminal which is temporarily assigned to the first subscriber A is recorded in a black list associated with the second subscriber B. In this case, the method according to the invention affords the advantage that incorrect classification of the connection request F2, F4 by the second subscriber B is avoided by removing the subscriber-related information, which falsifies the identity of the first subscriber A and relates to the registration state of the terminal associated with the first subscriber A, the MAC address, for example, in this case.

In another form of the invention, the communication apparatus SP1 is automatically configured after the connection request F2, F4 from the first subscriber A has been forwarded to the second subscriber B, any connection request addressed to the first subscriber A being forwarded to the terminal which is temporarily assigned to the first subscriber A as a result of the automatic configuration. This has the advantage, for example in the event of the terminal associated with the first subscriber A being temporarily assigned to the first subscriber A, that calls can be automatically forwarded to the terminal which is temporarily assigned to the first subscriber A.

In another form of the invention, the terminal associated with the first subscriber A is in a “roaming” state, and the communication apparatus SP1 removes information relating to the “roaming” state of the first subscriber A from the connection request F2, F4 before forwarding the connection request F2, F4. This has the advantage that the first subscriber A may stay in a communication network N2, N3 other than its home communication network N1, its terminal being in the “roaming” state and the method according to the invention nevertheless ensuring that incorrect classification of the connection request F2, F4 by the second subscriber B is avoided.

In another form of the invention, the connection request F2, F4 is an SIP invite message. This has the advantage that the method according to the invention can be used in a communication network N1, N2, N3 which uses an SIP-based communication protocol.

In another form of the invention, the server system SOPP authenticates the first subscriber A before the connection request F2, F4 from the first subscriber A is forwarded, the connection request F2, F4 being forwarded only when the authentication of the first subscriber A has been successful. This has the advantage that the identity of the first subscriber A can be checked, for example.

In another form of the invention, the first subscriber A transmits subscriber-related data to the server system SOPP for authentication purposes. This has the advantage that the identity of the first subscriber A can be checked on the basis of subscriber-related data, for example.

In another form of the invention, the subscriber-related data comprise a sender address and/or a PIN number and/or a password. This has the advantage that the identity of the first subscriber A can be checked on the basis of a sender address and/or a PIN number and/or a password, for example.

In another form of the invention, signaling data which are contained in the subscriber-related data and relate to the signaling route of the connection request F2, F4 can be evaluated. This has the advantage that information relating to the route, which has already been covered by the connection request F2, F4, in the communication network N1, N2, N3 can be checked, for example. This information may be represented, for example, by header entries in the connection request F2, F4 such as “Route:”, “Max-Forwards:” or “Via:”.

In another form of the invention, the first subscriber A can be authenticated by a registrar G1, G2, G3. This has the advantage that the server system SOPP can have the first subscriber A authenticated in an efficient manner by a separate network component.

In another form of the invention, the first subscriber A registers with a second registrar G2 situated in a communication network N2 other than the home communication network N1 of the first subscriber A, the second registrar G2 contacting a first registrar situated in the home communication network N1 of the first subscriber A for the purpose of authenticating the first subscriber A. This has the advantage that authentication can be carried out efficiently whenever the first subscriber A has registered in a communication network N2, N3 other than its home communication network N1.

In another form of the invention, the server system SOPP is situated in the home communication network N1 of the first subscriber A.

In another form of the invention, the server system SOPP is a terminal associated with the first subscriber A.

In another form of the invention, the server system SOPP is a computer program which can be executed on a terminal associated with the first subscriber A.

In another form of the invention, at least one of the communication networks N1, N2, N3 is an IP communication network.

1. A method for avoiding incorrect classification of desired messages as spam-over-Internet-telephony messages, comprising:
forwarding a connection request within communication networks from a terminal associated with a first subscriber to a terminal associated with a second subscriber, wherein
a first communication network is a home communication network of the first subscriber, and the terminal associated with the first subscriber is in a registration state characteristic of one of the communication networks in which the terminal associated with the first subscriber is registered at the time of the connection request,
subscriber-related information, which is included in the connection request, falsifies the identity of the first subscriber and relates to the registration state of the terminal associated with the first subscriber, such that incorrect classification of the connection request by the second subscriber may occur;
passing the connection request, via a server system, to the terminal associated with the second subscriber via a communication apparatus located in the home communication network; and
removing the subscriber-related information included in the connection request, thereby avoiding, at the communication apparatus, incorrect classification of the connection request by the second subscriber (B) before forwarding the connection request.

2. The method as claimed in claim 1,
wherein
the registration state characterizes one of the communication networks which is different from the home communication network and in which the terminal associated with the first subscriber is registered at the time of the connection request.

3. The method as claimed in
claim 1, wherein
removing to remove the subscriber-related information, a correct call number for the first subscriber is forwarded to the terminal associated with the second subscriber.

4. The method as claimed in
claim 1, wherein
the terminal associated with the first subscriber is permanently assigned to the first subscriber.

5. The method as claimed in
claim 1, wherein
the terminal associated with the first subscriber can be temporarily assigned to the first subscriber.

6. The method as claimed in claim 5,
wherein
the communication apparatus is automatically configured after the connection request from the first subscriber has been forwarded to the second subscriber, any connection request addressed to the first subscriber being forwarded to the terminal which is temporarily assigned to the first subscriber as a result of the automatic configuration.

7. The method as claimed in
claim 1, wherein
the terminal associated with the first subscriber is in a “roaming” state, and
the communication apparatus removes information relating to the “roaming” state of the first subscriber from the connection request before forwarding the connection request.

8. The method as claimed in
claim 1, wherein
the connection request is an SIP invite message.

9. The method as claimed in
claim 1, wherein
the server system authenticates the first subscriber before the connection request from the first subscriber is forwarded, the connection request being forwarded when the authentication of the first subscriber has been successful.

10. The method as claimed in
claim 1, wherein
the first subscriber transmits subscriber-related data to the server system for authentication purposes.

11. The method as claimed in
claim 1, wherein
the subscriber-related data comprise a sender address and/or a PIN number and/or a password.

12. The method as claimed in
claim 1, wherein
signaling data which are contained in the subscriber-related data and relate to the signaling route of the connection request can be evaluated.

13. The method as claimed in
claim 1, wherein
the first subscriber can be authenticated by a registrar.

14. The method as claimed in claim 13,
wherein
the first subscriber registers with a second registrar situated in one of the communication networks other than the home communication network of the first subscriber, the second registrar contacting a first registrar situated in the home communication network of the first subscriber for authenticating the first subscriber.

15. An apparatus for avoiding incorrect classification of desired messages as spam-over-Internet-telephony messages comprising:
a forwarding device for forwarding a connection request within communication networks from a terminal associated with a first subscriber to a terminal associated with a second subscriber;
a first communication network being configured as a home communication network of the first subscriber, wherein
the terminal associated with the first subscriber is in a registration state characteristic of one of the communication networks in which the terminal associated with the first subscriber is registered at the time of the connection request, and
subscriber-related information, which is included in the connection request, falsifies the identity of the first subscriber and relates to the registration state of the terminal associated with the first subscriber, such that incorrect classification of the connection request by the second subscriber may occur;
a server system for forwarding the connection request to the terminal associated with the second subscriber via a communication apparatus located in the home communication network; and
a removal device for removing the subscriber-related information, before the connection request is forwarded by the communication apparatus to avoid incorrect classification of the connection request by the second subscriber.

16. The apparatus as claimed in claim 15, the server system being situated in the home communication network of the first subscriber.

17. The apparatus as claimed in claim 15, the server system being a terminal associated with the first subscriber.

18. The apparatus as claimed in claim 15, the server system being a computer program which can be executed on a terminal associated with the first subscriber.

19. The apparatus as claimed in claim 15, at least one of the communication networks being an IP communication network.
